(19) United States
(12) Patent Application Publication
(10) Pub. No.: US 2023/0381881 A1
(43) Pub. Date: Nov. 30, 2023

(54) SYSTEMS AND METHODS FOR DISPENSING WELDING WIRE TO A SPOOL GUN

(71) Applicant: Illinois Tool Works Inc., Glenview, IL (US)

(72) Inventors: Sean J. Walkowski, Traverse City, MI (US); Gregory P. Bennett, Interlochen, MI (US); Galen White, Traverse City, MI (US); Randy A. Doctor, Eastport, MI (US)

(21) Appl. No.: 18/318,063

(22) Filed: May 16, 2023

Related U.S. Application Data
(60) Provisional application No. 63/345,500, filed on May 25, 2022.

(51) Int. Cl. B23K 9/133

(52) U.S. Cl. CPC B23K 9/1333

(57) ABSTRACT

Disclosed is a system for dispensing welding wire for a spool gun type welding torch. In particular, the disclosed system allows conversion of the spool gun type welding torch from a small wire spool (e.g., a one pound spool) to a much larger (e.g., 16 pound spool), enhancing efficiency, reducing set-up time relative to welding.

### CROSS REFERENCE TO RELATED APPLICATIONS

This application is a Non-Provisional Patent Application of U.S. Provisional Patent Application No. 63/345,500 entitled “Systems And Methods For Dispensing Welding Wire To A Spool Gun” filed May 25, 2022, which is herein incorporated by reference in its entirety.

### BACKGROUND

In some welding-type applications, a welding wire feeder may be used to feed welding wire from a wire spool to a welding torch for a welding operation. In some welding-type operations, it may be desirable for welding wire feeders to be portable. An example is a spool gun type welding torch, with a small spool of wire attached to the torch. In some welding-type operations, it may be desirable to easily exchange size and/or type wire spools and/or wire.

Thus, systems and methods that provide effective and simple exchange of wire spools is desirable.

### SUMMARY

The present disclosure relates generally to welding systems and, more particularly, to systems for dispensing welding wire for a spool gun type welding torch, substantially as illustrated by and described in connection with at least one of the figures, as set forth more completely in the claims.

These and other advantages, aspects and novel features of the present disclosure, as well as details of an illustrated example thereof, will be more fully understood from the following description and drawings.

### BRIEF DESCRIPTION OF THE DRAWINGS

FIG. 1 illustrates an example system for dispensing welding wire for a spool gun type welding torch, in accordance with aspects of this disclosure.

FIG. 2A illustrates an example spool gun type welding torch employing a torch mounted spool, in accordance with aspects of this disclosure.

FIG. 2B illustrates an example spool gun type welding torch employing the system provided in FIG. 1, in accordance with aspects of this disclosure.

The figures are not necessarily to scale. Where appropriate, similar or identical reference numbers are used to refer to similar or identical components.

### DETAILED DESCRIPTION

The present disclosure is directed to systems and methods for dispensing welding wire for a spool gun type welding torch. In particular, the disclosed system allows conversion of the spool gun type welding torch from a small wire spool (e.g., a one pound spool) to a much larger (e.g., 16 pound spool), enhancing efficiency, reducing set-up time relative to welding.

For example, the system includes a welding wire dispensing device employing a de-reeling arm, which is configured to rotate about a wire spool. The wire spool is arranged on a base, which is substantially parallel with the ground or floor, and the de-reeling arm rotates about a central axis of the wire spool. As the de-reeling arm rotates about the wire spool, electrode welding wire is drawn into a conduit connected to the de-reeling arm. The conduit channels the welding wire from the wire spool to a roller configured to direct the welding wire into a wire liner.

For example, the system is connected to a spool gun type welding torch, which includes a wire feeder. The wire feeder advances the welding wire through the system as it is unwound from the wire spool. In some examples, a shaft is arranged between the conduit and the roller, with the shaft configured to support the de-reeling arm and to rotate about the central axis (e.g., substantially collinear with a center of the wire spool).

A bearing supports the shaft (e.g., to a support structure) and allows rotation thereof as the shaft channels the welding wire from the conduit to the roller. A brake is arranged to contact a portion of the shaft and apply a predetermined amount of pressure against the shaft. In some examples, the amount of pressure is adjustable, such as by a fastener or set-screw.

Conventionally, a spool gun welding system is limited to welding with wire spools containing one pound of welding wire. This requires frequent replacement of the wire spool during a welding operation.

Advantageously, by employing the disclosed system for dispensing welding wire, a welder is able to use the same spool gun, but connected to a much larger wire spool (e.g., a 16 pound wire spool or more). This allows the welder to continue welding for longer, drastically reducing downtime caused by wire spool change-over. As such, the welder will have to stop a welding operation to change spools once every 16 pounds compared to once for every pound if they were using a one pound spool. The welder will see a substantial decrease in downtime due to wire change overs. The welder will now only have to change wire spools once every 16 pounds rather than once every pound. Also, the welder will experience less strain due to the spool gun now being one pound lighter.

Furthermore, at the manufacturing stage, spooling one pound spools of wire is more labor intensive, less efficient, and requires more packaging than spooling a 16 pound wire spool. The disclosed system allows the customer to use current equipment and use larger spools without the costly investment of a push pull system, for example.

In disclosed examples, a system for dispensing welding wire includes a de-reeling arm to rotate about a wire spool; a roller to direct the welding wire into a wire liner; and a conduit connected to the de-reeling arm and configured to channel the welding wire from the wire spool to the roller as the welding wire is unwound from the wire spool.

In some examples, a shaft between the conduit and the roller, the shaft configured to support the de-reeling arm and to rotate about an axis substantially collinear with a center of the wire spool. In examples, the shaft channels the welding wire from the conduit to the roller.

In some examples, a bearing to support and allow rotation of the shaft, wherein the de-reeling arm is secured to the shaft. In examples, a brake configured to apply a predetermined amount of pressure against the shaft. In examples, the brake is adjustable and operable to change the amount of pressure against the shaft.

In some examples, a base to support and align the wire spool with a rotation axis of the shaft; and a support structure to maintain the position of the bearing and the brake relative to the base or the welding wire spool. In examples, the base secures the wire spool to prevent rotation of the wire spool during a dispensing operation.

In some examples, the welding wire spool is a 16 or a 22 pound spool of metallic wire.

In some examples, the wire liner is connected to a spool gun type welding torch. In examples, the welding wire is advanced by a wire feeder incorporated with the spool gun.

In some disclosed examples, a system for dispensing welding wire includes a spool gun type welding torch that includes a wire feeder; and a welding wire dispensing device including a de-reeling arm to rotate about the wire spool; a roller to direct the welding wire into a wire liner; and a conduit connected to the de-reeling arm and configured to channel the welding wire from the wire spool to the roller as the welding wire is unwound from the wire spool as the welding wire advances through the wire feeder.

In some examples, the wire feeder includes one or more drive rolls to drive the welding wire in response to a user operated trigger. In examples, rotation of the de-reeling arm is driven by the welding wire advancing through the wire feeder. In examples, the welding wire dispensing device further comprises a shaft between the conduit and the roller, the shaft configured to support the de-reeling arm and to rotate about an axis substantially collinear with a center of the wire spool.

In some examples, the welding wire dispensing device further comprises a brake configured to apply a predetermined amount of pressure against the shaft. In examples, the brake is adjustable to change the amount of pressure against the shaft.

In some examples, the support structure further comprises a base to support the wire spool, and a plurality of wheels to support the base. In examples, the welding wire spool is a 16 or a 22 pound spool of metallic wire.

In some examples, a welding power supply to provide one or more of power or shielding gas to the torch via one or more cables.

The term “welding-type system,” as used herein, includes any device capable of supplying power suitable for welding, plasma cutting, induction heating, Carbon Arc Cutting-Air (e.g., CAC-A, or gouging), and/or hot wire welding/preheating (including laser welding and laser cladding), including inverters, converters, choppers, resonant power supplies, quasi-resonant power supplies, etc., as well as control circuitry and other ancillary circuitry associated therewith.

As used herein, the term “welding-type power” refers to power suitable for welding, plasma cutting, induction heating, CAC-A and/or hot wire welding/preheating (including laser welding and laser cladding).

As used herein, the term “welding-type power supply” and/or “power supply” refers to any device capable of, when power is applied thereto, supplying welding, plasma cutting, induction heating, CAC-A and/or hot wire welding/preheating (including laser welding and laser cladding) power, including but not limited to inverters, converters, resonant power supplies, quasi-resonant power supplies, and the like, as well as control circuitry and other ancillary circuitry associated therewith. The term can include engine driven power supplies, energy storage devices, and/or circuitry and/or connections to draw power from a variety of external power sources.

As used herein, the term “wire feeder” includes the motor or mechanism that drives the wire, the mounting for the wire, and controls related thereto, and associated hardware and software.

As used herein, the term “torch,” “welding torch,” “welding tool” or “welding-type tool” refers to a device configured to be manipulated to perform a welding-related task, and can include a hand-held welding torch, robotic welding torch, gun, gouging tool, cutting tool, or other device used to implement a welding process.

As used herein, a “circuit,” or “circuitry,” includes any analog and/or digital components, power and/or control elements, such as a microprocessor, digital signal processor (DSP), software, and the like, discrete and/or integrated components, or portions and/or combinations thereof.

The terms “control circuit,” “control circuitry,” and/or “controller,” as used herein, may include digital and/or analog circuitry, discrete and/or integrated circuitry, microprocessors, digital signal processors (DSPs), Field Programmable Gate Arrays (FPGAs), and/or other logic circuitry, and/or associated software, hardware, and/or firmware. Control circuits or control circuitry may be located on one or more circuit boards that form part or all of a controller, and are used to control a welding process, a device such as a power source or wire feeder, and/or any other type of welding-related system.

As used herein, the term “memory” includes volatile and non-volatile memory devices and/or other storage device.

As used herein, the term “energy storage device” is any device that stores energy, such as, for example, a battery, a supercapacitor, etc.

As used herein, the term “welding mode,” “welding process,” “welding-type process” or “welding operation” refers to the type of process or output used, such as current-controlled (CC), voltage-controlled (CV), pulsed, gas metal arc welding (GMAW), flux-cored arc welding (FCAW), gas tungsten arc welding (GTAW, e.g., TIG), shielded metal arc welding (SMAW), spray, short circuit, CAC-A, gouging process, plasma cutting, cutting process, and/or any other type of welding process.

As used herein, the term “welding program” or “weld program” includes at least a set of welding parameters for controlling a weld. A welding program may further include other software, algorithms, processes, or other logic to control one or more welding-type devices to perform a weld.

As used herein, “power conversion circuitry” and/or “power conversion circuits” refer to circuitry and/or electrical components that convert electrical power from one or more first forms (e.g., power output by a generator) to one or more second forms having any combination of voltage, current, frequency, and/or response characteristics. The power conversion circuitry may include safety circuitry, output selection circuitry, measurement and/or control circuitry, and/or any other circuits to provide appropriate features.

As used herein, the terms “first” and “second” may be used to enumerate different components or elements of the same type, and do not necessarily imply any particular order.

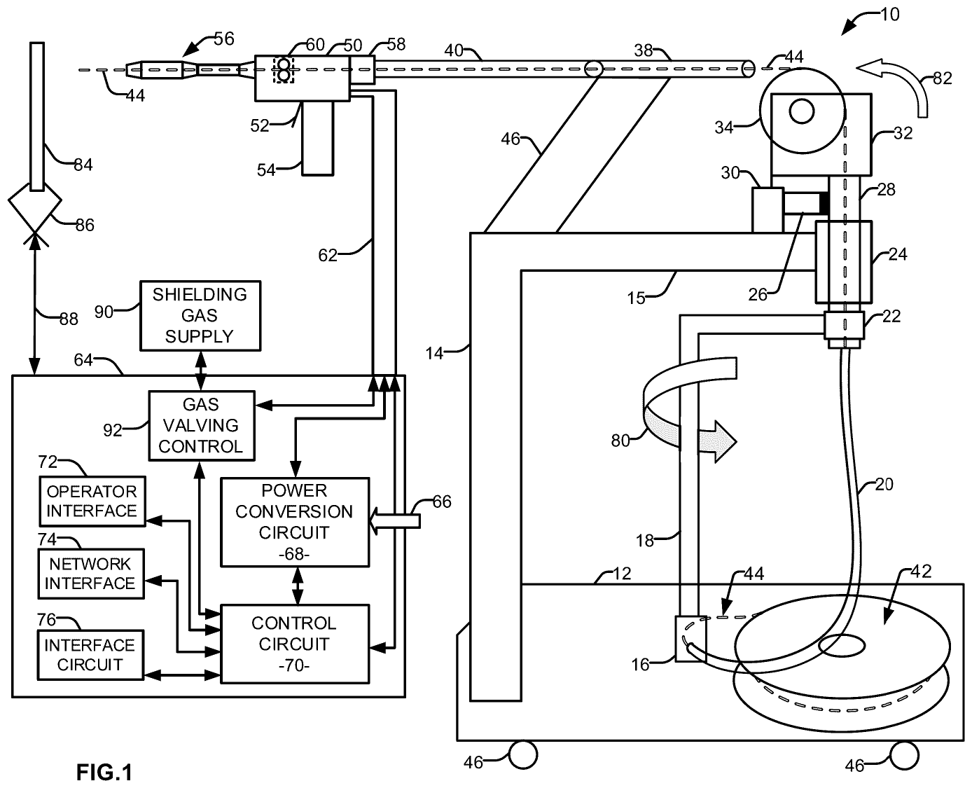

FIG. 1 illustrates an example system 10 for dispensing welding wire for a spool gun type welding torch 50. As shown in FIG. 1, the spool gun type welding torch 50 is coupled to the system 10 via one or more conduits 40 and coupled to a welding type power supply 64 via conductors or conduits 62. In the illustrated example, the power supply 64 is separate from the spool gun type welding torch 50, such that the torch 50 and/or the system 10 may be positioned near a welding location (at a workpiece 84) at some distance from the power supply 64. Terminals are typically provided on the power supply 64 and on the torch 50 to allow the conductors 62 or conduits to allow for power and gas to be provided to the torch 50 from the power supply 64, and to allow data to be exchanged between the two devices.

The disclosed system 10 is driven by a wire feeder 60 of the torch 50, which causes rotation of a de-reeling arm 18 around a stationary wire spool 42, as indicated by arrow 80. The arm 18 is hoisted by vertical 14 and/or horizontal 15 members of a support structure. At the end of the horizontal member 15 is an attached bearing 24, on which the de-reeling arm 18 rotates. An electrode welding wire 44 from the spool 42 is directed into an inlet 16 and channeled through a conduit 20 and then through a shaft 28. For example, the shaft 28 rotates within the bearing 24, which drives rotation of the arm 18, connected to the shaft 28 by a coupler or connector 22.

As the wire feeder 60 advances the wire 44 through the system 10, the wire 44 is channeled through the inlet 16, the conduit 20, the shaft 28, across a roller 34 (mounted in a housing 32), allowing the wire 44 to traverse from vertical movement to horizontal movement smoothly, as indicated by arrow 82. The roller 34 and/or housing 32 is connected to the support structure, such as by the horizontal support 15, and rotates on a bearing for minimum resistance for the wire 44. As the wire 44 transitions off the roller 34, it feeds into a welding liner 38. The liner 38 is secured by a liner mounting bracket 46, also connected to the horizontal member 15. The wire 44 is fed through the liner 38 and into the conduit 40 connected to an input 58 of the torch 50, driven by the wire feeder 60.

To prevent the de-reeling arm 18 from over-spooling the wire 44 from the spool 42, and thereby causing the wire 44 to tangle and/or snag, a brake 26 is employed to arrest movement of the arm 18 as soon as the wire feeder 60 stops advancing the wire. For example, the brake 26 is mounted to the horizontal member 15 via a brake support member 30. In the example of FIG. 1, the brake 26 can extend from the member 30 to make contact with and apply pressure to the rotating shaft 28. A position of the brake 26 can be adjusted to change the amount of pressure on the shaft 28. This ensures the shaft 28 is able to rotate (with the de-reeling arm 18) as the wire 44 is advanced through the wire feeder 60, yet stops rotating when the wire feeder 60 stops. The responsiveness of the brake/shaft interface to movement of the wire feeder 60 ensures slack is kept at a minimum as the wire 44 travels through the system 10.

In some examples, the brake 26 is a friction brake, making physical contact with an external surface the shaft 28, thereby regulating rotational speed of the shaft via friction at the brake/shaft interface. In some examples, the brake 26 may additionally or alternatively include a magnetic type brake, a hydraulic brake, or air brake, as a list of non-limiting examples. As disclosed herein, the amount of pressure against the shaft from the brake can be set and/or adjusted manually and/or automatically (e.g., via an actuator responsive to one or more of a feedback signal, a sensor reading, a user input, etc.).

The torch 50 can include the wire feeder 60, a handle 54 and trigger 52. The wire feeder 60 includes components for feeding wire to the torch 50 and thereby to the welding operation, under the control of control circuit 70. As illustrated, the drive components and control components of the wire feeder 60 are included within the torch 50.

The wire 44 is channeled through a nozzle 56 assembly to electrify the wire as it advances to a welding workpiece 84. The power supply 64 is configured to provide power from the power supply 64, and shielding gas from a shielding gas supply 90 to the torch 50. The torch 50 may control feeding of the wire 44, power, and/or gas, responsive to a trigger 52, for example. A work cable 88 is run to the welding workpiece 84 via a clamp 86 so as to complete an electrical circuit between the power supply 64 and the workpiece 84 for maintaining the welding arc during the operation.

The power supply 64 is configured for weld settings (e.g., weld parameters, such as voltage, wire feed speed, current, gas flow, inductance, physical weld parameters, welding programs, etc.) to be selected by the operator and/or a welding sequence, such as via an operator interface 72 provided on the power supply 64. The operator interface 72 will typically be incorporated into a front faceplate of the power supply 64, and may allow for selection of settings such as the weld process, the type of wire to be used, voltage and current settings, and so forth. These weld settings are communicated to a control circuit 70 within the power supply 64. The control circuit 70 operates to control generation of welding power output that is supplied to the welding wire 44 for carrying out the desired welding operation. The shielding gas from the shielding gas supply 90 is fed through a gas valving control 92.

The control circuit 70 is coupled to power conversion circuit 68. This power conversion circuit 68 is adapted to create the output power. Various power conversion circuits may be employed, including choppers, boost circuitry, buck circuitry, inverters, converters, and/or other switched mode power supply circuitry, and/or any other type of power conversion circuitry. The power conversion circuit 68 is coupled to a source of electrical power as indicated by arrow 66. The power applied to the power conversion circuit 68 may originate in the power grid, although other sources of power may also be used, such as power generated by an engine-driven generator, batteries, fuel cells or other alternative sources. The power supply 64 may also include a network interface circuit 74 and/or an interface circuit 76 configured to allow the control circuit 70 to exchange signals with the torch 50 and/or other auxiliary devices.

In some examples, the support structure includes a base 12 configured to support wire spool 42 (e.g., a 16 pound spool). One or more wheels 46 or other member can support the system. In some examples, the base 12 is configured to support up to a sixty pound spool of wire. In some examples, the spool 42 can be mounted vertically, configured to unwind toward the roller 34 without the aid of a de-reeling arm. Operation of a vertically mounted spool may employ one or more of a brake or a motor to control rotation of the spool as the wire feeder starts, maintains, and stops advancing wire.

For instance, the base 12 can include a post or shaft to extend through a central opening of the wire spool 42. Additionally or alternatively, a support can surround the frame of the wire spool 42 to maintain the position or orientation of the wire spool 42 during a welding operation. The support may include a ridge about all or a portion of the spool, one or more extensions, fasteners, or clamps, as a list of non-limiting examples.

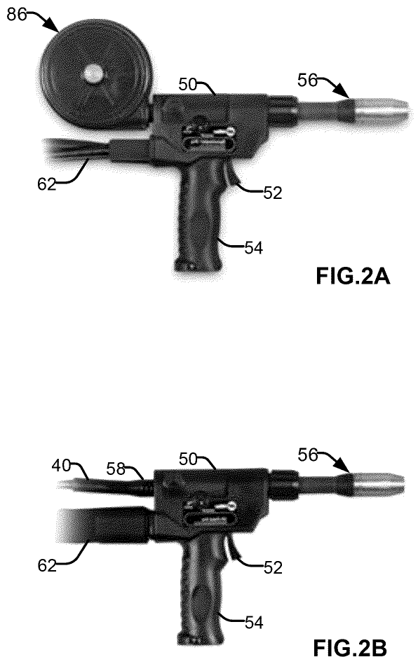

FIG. 2A illustrates a conventional spool gun torch 50 set-up with a one-pound spool canister 86 mounted thereon. By contrast, FIG. 2B illustrates the same spool gun torch 50 converted to use the wire dispensing system 10. As shown, the canister 86 has been replaced with the conduit liner 40 that connects the torch 50 with the system 10. This drastically lowers the weight of the spool gun and makes it easier for the welder to manipulate.

The present methods and systems may be realized in hardware, software, and/or a combination of hardware and software. Example implementations include an application specific integrated circuit and/or a programmable control circuit. The present methods and/or systems may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip. Some implementations may comprise a non-transitory machine-readable (e.g., computer readable) medium (e.g., FLASH drive, optical disk, magnetic storage disk, or the like) having stored thereon one or more lines of code executable by a machine, thereby causing the machine to perform processes as described herein.

As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled or not enabled (e.g., by a user-configurable setting, factory trim, etc.).

While the present method and/or system has been described with reference to certain implementations, it will be understood by those skilled in the art that various changes may be made and equivalents may be substituted without departing from the scope of the present method and/or system. For example, block and/or components of disclosed examples may be combined, divided, re-arranged, and/or otherwise modified. In addition, many modifications may be made to adapt a particular situation or material to the teachings of the present disclosure without departing from its scope. Therefore, the present method and/or system are not limited to the particular implementations disclosed. Instead, the present method and/or system will include all implementations falling within the scope of the appended claims, both literally and under the doctrine of equivalents.

1. A system for dispensing welding wire comprising:
a de-reeling arm to rotate about a wire spool;
a roller to direct the welding wire into a wire liner; and
a conduit connected to the de-reeling arm and configured to channel the welding wire from the wire spool to the roller as the welding wire is unwound from the wire spool.

2. The system of claim 1, further comprising a shaft between the conduit and the roller, the shaft configured to support the de-reeling arm and to rotate about an axis substantially collinear with a center of the wire spool.

3. The system of claim 2, wherein the shaft channels the welding wire from the conduit to the roller.

4. The system of claim 2, further comprising a bearing to support and allow rotation of the shaft, wherein the de-reeling arm is secured to the shaft.

5. The system of claim 4, further comprising a brake configured to apply a predetermined amount of pressure against the shaft.

6. The system of claim 5, wherein the brake is adjustable and operable to change the amount of pressure against the shaft.

7. The system of claim 5, further comprising:
a base to support and align the wire spool with a rotation axis of the shaft; and
a support structure to maintain the position of the bearing and the brake relative to the base or the welding wire spool.

8. The system of claim 7, wherein the base secures the wire spool to prevent rotation of the wire spool during a dispensing operation.

9. The system of claim 1, wherein the welding wire spool is a 16 or a 22 pound spool of metallic wire.

10. The system of claim 1, wherein the wire liner is connected to a spool gun type welding torch.

11. The system of claim 10, wherein the welding wire is advanced by a wire feeder incorporated with the spool gun.

12. A system for dispensing welding wire comprising:
a spool gun type welding torch that includes a wire feeder; and
a welding wire dispensing device comprising:
a de-reeling arm to rotate about the wire spool;
a roller to direct the welding wire into a wire liner; and
a conduit connected to the de-reeling arm and configured to channel the welding wire from the wire spool to the roller as the welding wire is unwound from the wire spool as the welding wire advances through the wire feeder.

13. The system of claim 12, wherein the wire feeder includes one or more drive rolls to drive the welding wire in response to a user operated trigger.

14. The system of claim 13, wherein rotation of the de-reeling arm is driven by the welding wire advancing through the wire feeder.

15. The system of claim 12, wherein the welding wire dispensing device further comprises a shaft between the conduit and the roller, the shaft configured to support the de-reeling arm and to rotate about an axis substantially collinear with a center of the wire spool.

16. The system of claim 15, wherein the welding wire dispensing device further comprises a brake configured to apply a predetermined amount of pressure against the shaft.

17. The system of claim 16, wherein the brake is adjustable to change the amount of pressure against the shaft.

18. The system of claim 12, wherein the support structure further comprises a base to support the wire spool, and a plurality of wheels to support the base.

19. The system of claim 12, wherein the welding wire spool is a 16 or a 22 pound spool of metallic wire.

20. The system of claim 12, further comprising a welding power supply to provide one or more of power or shielding gas to the torch via one or more cables.
